(19) United States
(12) Patent Application Publication
(10) Pub. No.: US 2007/0246628 A1
(43) Pub. Date: Oct. 25, 2007

(54) Hanger assembly and method of hanging items

(76) Inventor: Ronald Wayne Palmer, Greensburg, PA (US)

Correspondence Address: Lawrence R. Burns, Esq., 310 Coulter Bldg, 231 S. Main St., Greensburg, PA, 15601, US

(21) Appl. No.: 11/406,887

(22) Filed: Apr. 19, 2006

(51) Int. Cl. F16B 45/00

(52) U.S. Cl. 248/304

(57) ABSTRACT

A detachable and non-damaging hanger assembly for use with vertical support structures located either inside or outside a building. The hanger assembly comprises a central bracket having means for removable attachment a support structure with easily removable rod-like hanger members or arms extending upwardly, downwardly, or both, from the central bracket. The members or arms extending outwardly, preferably in a curved manner, from the support structure and have on the outer ends of the arms means for hanging decorative or useful items. The method consists of attaching the central bracket to a vertical support structure by means of an adjustable belt that extends around the circumference of the support structure. With the central bracket attached to the support structure one end of the rod members is then telescopically engaged in a perforation formed in the central bracket so that the rod members are releasably held by the central bracket. Items may then be hung on the remote ends of the rod members from the central bracket.

### BACKGROUND OF THE INVENTION

Hangers for decorative or useful items are used in the home, office and yard environment. Live plants and other items of beauty or usefulness are usually found hanging on vertical support structures, either located inside or outside of buildings. Almost any vertical support structure in or around the home or office, may, or has been used to engage a hanger so that an item maybe hung therefrom. Affixing the hangers to the support structures takes many forms. The most damaging is the permanent type of attachment that uses nails or screws to affix the hanger to the vertical support to the coat hanger type of attachment where an uppermost loop may be engaged over an extension of the vertical support (tree limb). It has not been the practice, nor does one see many devices that are removable support hangers for vertical support structures. Trees and tree limbs, for example, are a natural occurring vertical support structure and are used to hang bird feeders, wind chimes, swings, and many other items. Usually a coat hanger type of wire is used with the upper end of the wire bent so as to engage the limb and items are then attached to the lower end of the wire. Where other type hangers are used they usually require that nails or screws be driven into the tree structure thereby possibly permanently damaging the living organism.

### BRIEF SUMMARY OF THE INVENTION

According to the present invention there is disclosed a hanger assembly for a vertical support structure. The hanger assembly has a central bracket with means for abutting and attaching to the vertical support structure. The central bracket also provides for upwardly and downwardly extending rod members to be attached to the bracket. The rod members have on their outermost ends means for hanging items thereon. Preferably the means of attachment between the rod members and the central bracket comprises a perforation formed through the body of the central bracket so that one end of the rod members may be telescopically engaged with the perforation so as to be releasably held to the bracket.

This invention also contemplates the method of hanging items from a vertical support structure, which comprise the steps of forming a bracket with a perforation through the body thereof. The perforated bracket is then attached to a vertical support structure preferably with an adjustable belt that can be fastened around the circumference of the support structure. Rod members may then have one of their ends placed in the perforation of the bracket so as to be telescopically engaged thereto and have their other ends extend outwardly from the support structure foe the hanging of items and especially the hanging of decorative items.

### BRIEF DESCRIPTION OF THE DRAWINGS

FIG. 1 is a perspective view of the hanger according to the present invention.

FIG. 2 is a top plan view of the hanger according to the present invention.

FIG. 3 is the right-side plan view of the hanger according to the present invention

FIG. 4 is a front view of the hanger according to the present invention.

FIG. 5 is a bottom plan view of the hanger according to the present invention.

FIG. 6 is a rear view of the hanger according to the present invention.

FIG. 7 is a left-side view of the hanger according to the present invention.

FIG. 8 is a fragmentary perspective of the hanger according to the present invention.

FIG. 9 is a front fragmentary view of the hanger according to the present invention.

FIG. 10 is a rear fragmentary view of the hanger according to the present invention.

FIG. 11 is a top fragmentary view of the hanger according to the present invention.

FIG. 12 is a bottom fragmentary view of the hanger according to the present invention.

FIG. 13 is a left side fragmentary view of the hanger according to the present invention.

FIG. 14 is a sectional view taken on line 14-14 of FIG. 9 of the hanger according to the present invention.

FIG. 15 is a sectional view taken on line 15-15 of FIG. 9 of the hanger according to the present invention.

FIG. 16 is a fragmentary view of an alternative embodiment of the hanger according to the present invention.

FIG. 17 is a perspective view of an alternative embodiment of the invention.

FIG. 18 is a side view of an alternate embodiment of the present invention.

FIG. 19 is a sectional view through line 19-19 in FIG. 18.

FIG. 20 is a sectional view of line 20-20 in FIG. 18.

### OBJECTS OF THE INVENTION

It is an object of the present invention to provide a removable hanger assembly for vertical support structures.

It is an object of the present invention to provide a hanger for vertical support structures with removable arms for hanging items thereon.

It is an object of the present invention to provide a removable hanger bracket for attachment to a tree without any damage to the tree.

It is an object of the present invention to provide a removable hanger for a tree or decorative column without damaging the vertical structure.

It is an object of the present invention to provide non-damaging hangers for vertical support structures.

It is an object of the present invention to provide a removable hanger bracket with telescopically interchangeable arms for hanging decorative items thereon.

It is an object of the present invention to provide a hanger assembly that may be removably strapped to a vertical support structure such as a tree.

It is an object of the present invention to provide a hanger that may be installed and removed from a vertical support structure without the use of tools or other fastening hardware.

### DETAILED DESCRIPTION OF THE DRAWINGS

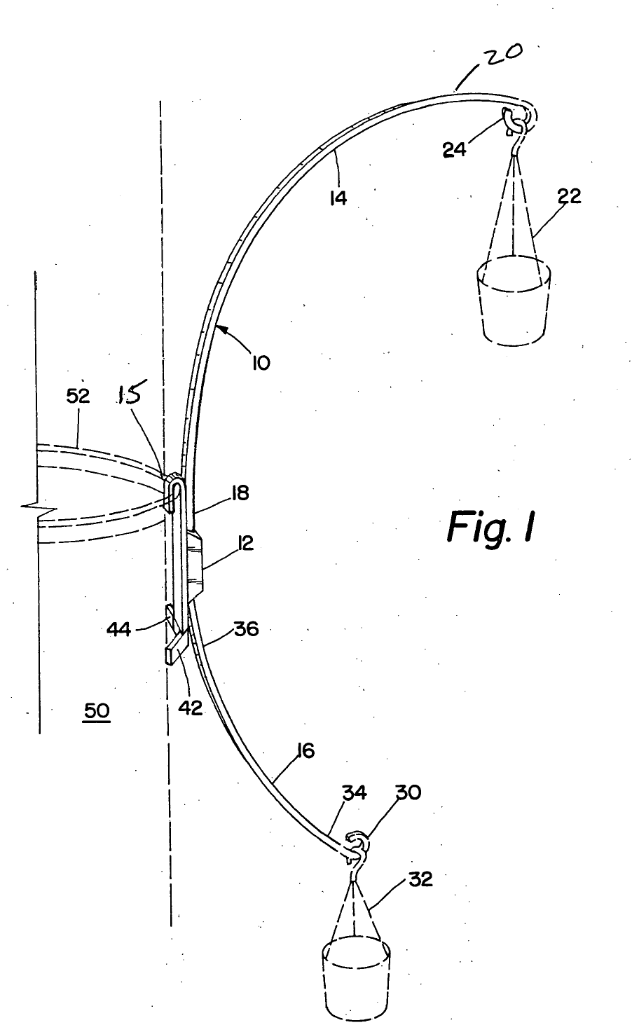

What is shown in FIG. 1 is a perspective view of the hanger 10 according to the present invention. A hanger assembly 10 is shown having a central bracket 12 with an upper rod hanger 14 and a lower rod hanger 16. The upper rod hanger 14 has one end 18 and an opposing end 20. The end 18 of rod hanger 14 is adapted to attach to the central bracket 12 and be supported by the central bracket 12 such decorative item such as 22 may be hung from the end 20. The end 20 of rod member 14 has means 24 thereon for hanging a decorative item 22. The lower extending rod member 16 has one end 36 and an opposing end 34. On the end 34 is located means 30 for hanging a decorative item 32 and is located on end 34 of rod member 16. Rod member 16 has an end 36 to be inserted into the lower end of the central support hanger 12 and to be supported thereby. The central hanger 12 has abutment arms 42 and 44 they are adapted to abut an upstanding vertical support member 50. An adjustable belt 52 with a releasable buckle fits around the circumference of the upper support of the vertical support member 50 and loop 15 on the hanger 12 engages the belt 52 so as to be supported by the vertical support member 50. The abutment arms 42 and 44 abut the outer most circumference of vertical support member 50 thereby providing the necessary structural support to stabilize the entire hanger assembly 10.

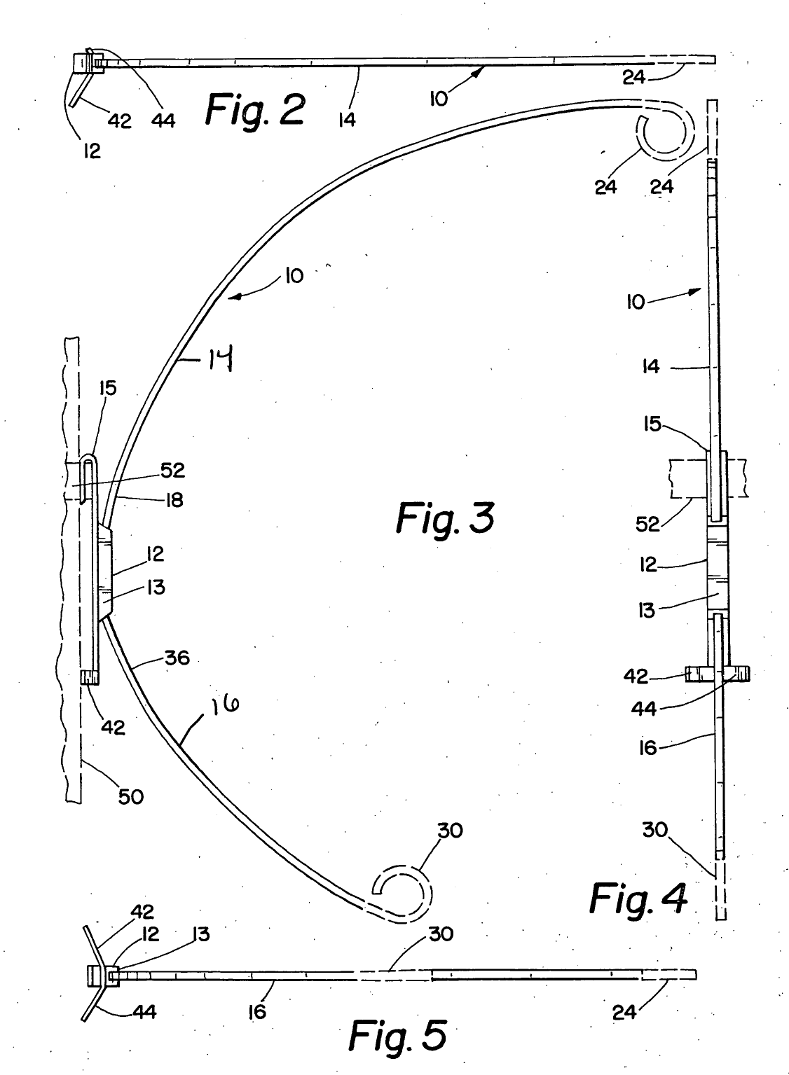

What is shown in FIG. 2 is a top plan view of the hanger assembly 10 looking down on the upwardly extending rod 14. The abutment arms 42 and 44 are shown extending outwardly from the central bracket 12 from above.

What is shown in FIG. 3 is the hanger assembly 10 shown with the central bracket 12 and the upwardly extending rod 14 and lower extending rod 16. Rods 14 and 16 telescopically engage the central bracket 12 at 13, which provides a telescopic engagement for the ends 18 of rod 14, and 36 of lower extending rod 16. The vertical support member 50 is shown therein and the abutment arm 42 is shown on the central bracket 12. The central bracket 12 has a loop as is shown at 15 for engaging the strap 52 that extends around the circumference of the vertical support member 50. The upper end of rod 14 has a loop (24), which may be an attachment mechanism for holding an item, and the lower end of rod 16 has a loop 30 for hanging an item.

What is shown in FIG. 4 is a front view of the hanger assembly 12 showing the upperwardly extending rod 14 and the lowerly extending rod 16. Loops 24 and 30 are shown as a means for attaching decorative items to the upperwardly extending arm 14 and lowerwardly extending arm 16. Loops 14 and 16 telescopically engage the central bracket 12 on the body 13 and the strap 52 is shown engaged with the loop 15 that is located on the central bracket 12.

What is shown in FIG. 5 is a bottom plan view of the central hanger assembly 12 showing the lowerwardly extending rod 16 and having a loop 30 thereon for holding an item. The central bracket 12 is shown with its body 13 telescopically engaging the end 36 of the rod 16 and the abutment arms 44 and 42 are again shown extending outwardly from the central bracket 12 so as to contract the vertical support member 50 (not shown).

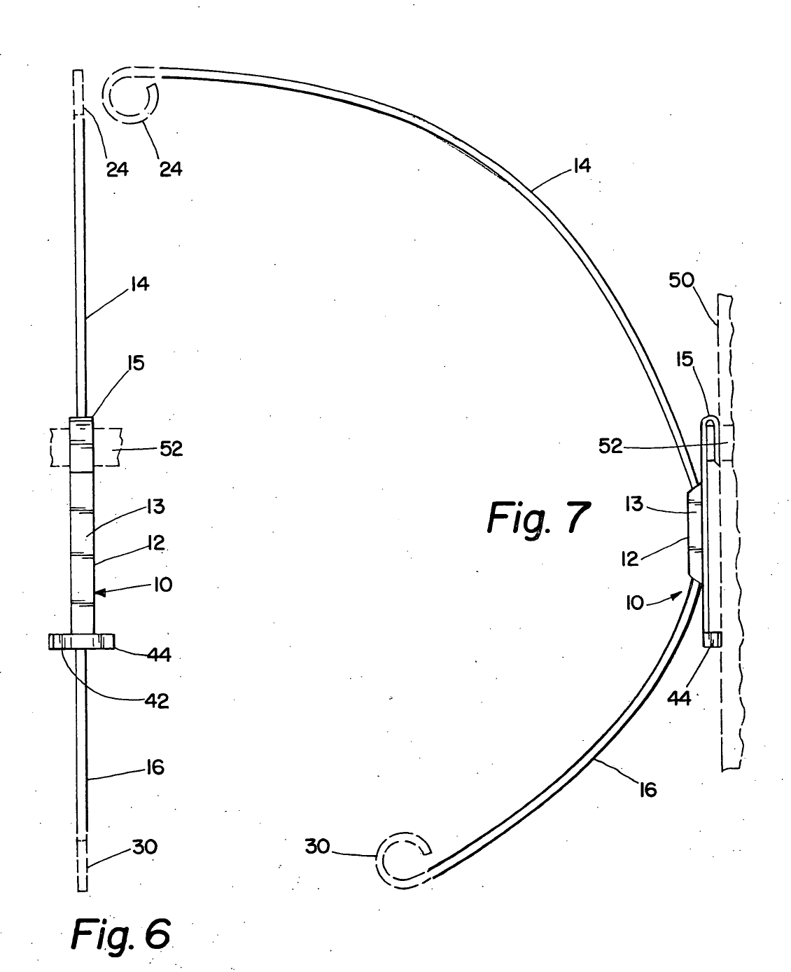

What is shown in FIG. 6 is a rear view of the hanger assembly 10 according to the present invention. FIG. 6 shows the upwardly extending rod member 14 and lowerly extending rod member 16 with the loops 24 and 30 that are used to hang the desired items and the central bracket 12 with the means 13 that is used to telescopically engage and hold the rod members 14 and 16. The abutment arms are shown in 42 and 44 and the strap 52 is shown with the loop 15 engaged over the strap 52.

What is shown in FIG. 7 is a left-side view of the hanger assembly 10 according to the present invention. The hanger assembly 10 is shown on a vertical support member 50 shown by a dotted line. The central bracket 12 has portion 13 that telescopically engages the upperwardly extending rods 14 and the lowerly extending rods 16 with the central bracket 12. Central bracket 12 has the loop 15 that extends up and over the belt 52 so as to provide support of the central bracket 12 on the vertical support 50. Abutment arm 44 is shown abutting the vertical support 50 to stabilize the hanger assembly 10 while the loops 24 and 30 support a decorative item.

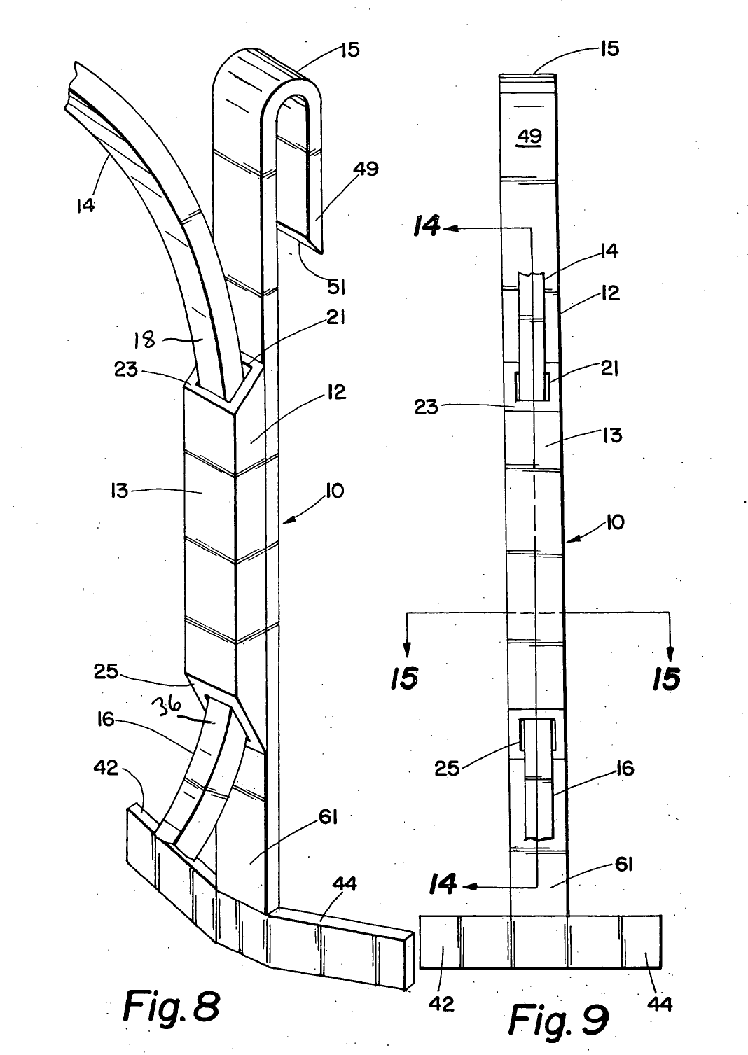

What is shown in FIG. 8 is a fragmentary perspective of the hanger assembly 10 according to the present invention. The central bracket 12 is shown having means 13 for telescopically engaging the rods 14 and 16. The portion 13 has a central perforation 21 that extends from the end 23 towards the other end 25 of the portion 13 on central bracket 12. The perforation may extend entirely through the portion 13 from top 23 to bottom 25. In this manner the rectangular rods of 14 and 16 maybe inserted into the perforation 21 through 13 and be retained therein. The central bracket 12 has the upper loop 15 shown which comprises lowerwardly extending section 49 to its lower end 51. By placing the loop section 15 over the belt 52 section 49 (not shown) is held captive and supported between the vertical support 50 (not shown) and the belt 52. The lower abutment arms 42 and 44 are shown at the lower end of 61 of the central bracket 12.

What is shown in FIG. 9 is a front fragmentary view of the hanger assembly 10 according to the present invention. Again shown therein is the portion 13 of the bracket 12 showing the perforation 21 as it extends from edge 23 down to edge 25 to form a telescopic reception area for the end 18 of rods 14 and the end 36 of rod 16. The abutment arms 42 and 44 are shown at the lower end 61 of the central bracket 12 and the upper loop area 15 is shown with the side 49 facing the reader.

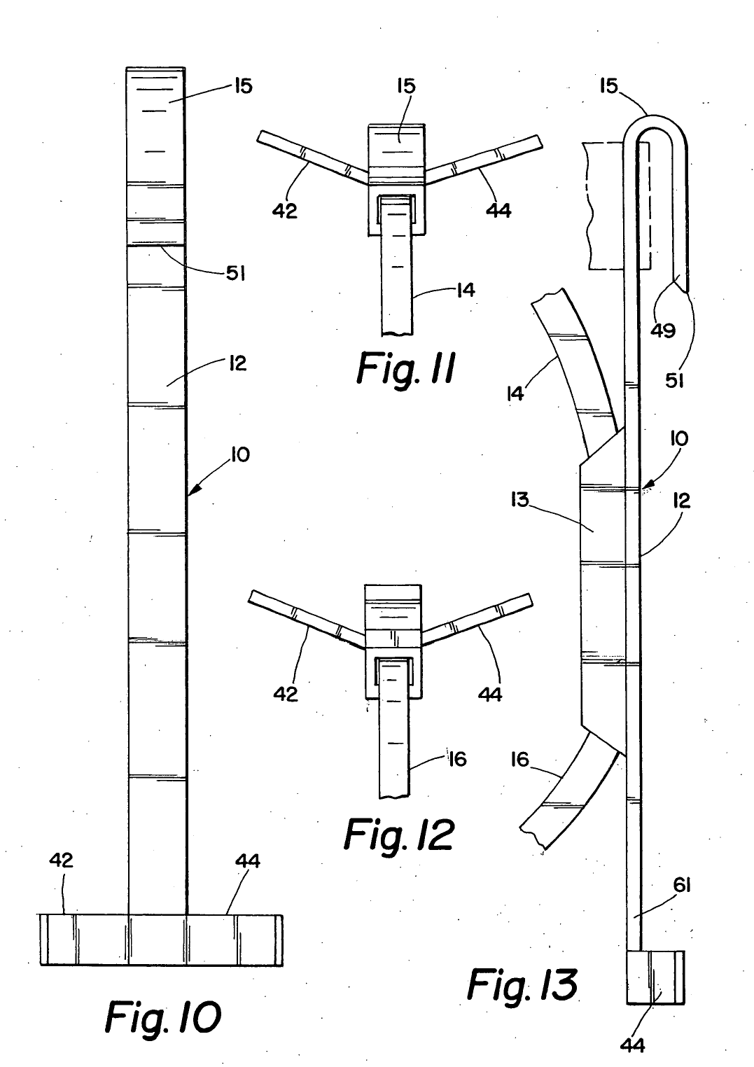

What is shown in FIGS. 10, 11, 12 and 13 is again the hanger assembly 10 having the central bracket 12 with the upward loop 15 and abutment brackets 42 and 44. The central bracket 12 has a portion 13 where the upper rods 14 and the lower rod 16 are telescopically engaged and the central bracket has an upper loop 15 engagement with the strap 52 (not shown). The loop edge 15 has the extension 49 that is for extending down over the belt loop 52 to hold the bracket on the vertical support structure. Again the abutment surface 44 is found on the lower end 61 of the central bracket 12.

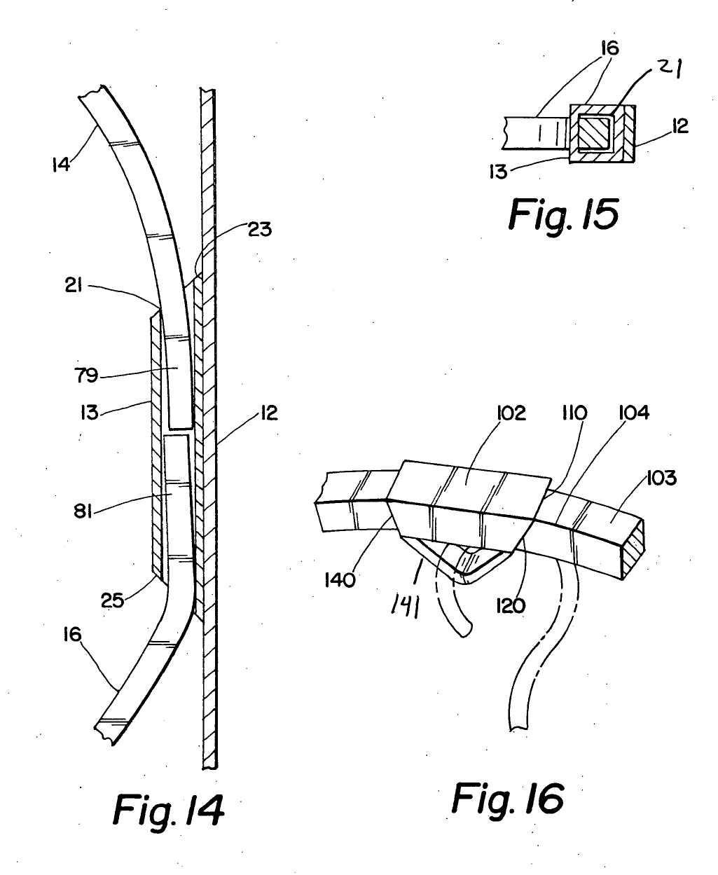

What is shown in FIG. 14 is again the central bracket 12 having an upper rod 14 and lower rod 16 shown therein. The upper rod 14 has an end 79 and the lower rod 16 has end 81. The ends 79 and 81 are formed in the perforation 21 that extends through the portion 13 of the central bracket 12

What is shown in FIG. 15 is a sectional view of 15-15 of FIG. 9 of the central bracket assembly 12 according to the present invention. The central bracket 12 has a body 13 through which a perforation 21 extends. The perforation 21 and the rod end 16 form cooperating elements of telescopic engagement with on another so as to hold rod 16 in place.

What is shown in FIG. 16 is a slide member 102 with a perforation 110 that extends from an end 120 to another end 140 and the rectangular rod member 104 extends there through. The bracket 102 is slidable on the rod member and a hook 141 is used to hold a desired item on the hanger assembly

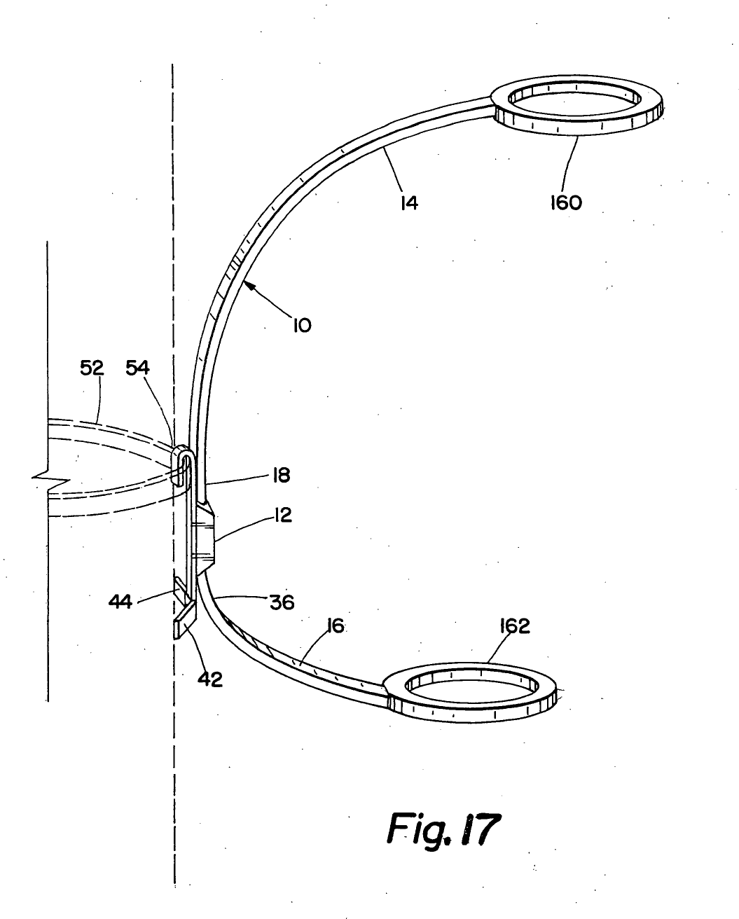

What is shown in FIG. 17 is a perspective view of an alternative embodiment of the hanger according to the present invention. The hanger 10 has the same central bracket 12 that attaches to the releasable belt 52 that is used to secure the bracket to the vertically upstanding support 50. The central bracket 12 has the abutment surfaces 42 and 44 that abut the vertically upstanding support 50. Rods 14 and 16 have ends 10 and 36 that telescopically engage with the central perforation formed vertically through the body 13 of the central bracket 12. On the ends of the rods 14 and 16 are located plant or item holders 124 and 130.

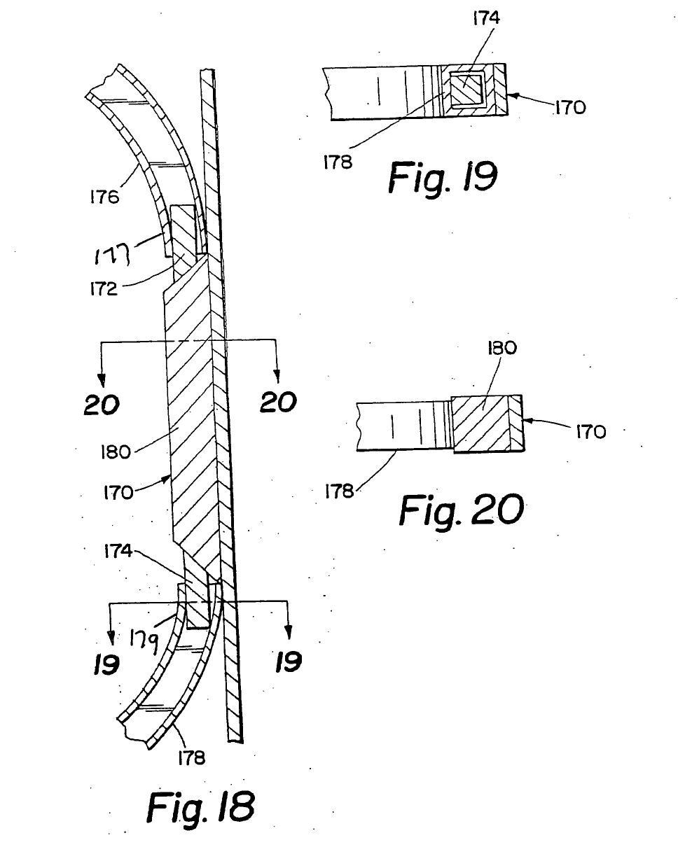

What is shown in FIG. 18 is an alternate embodiment of the bracket 170 according to the present invention. The upper rod hanger 176 is shown in a tubular form and the lower rod hanger is shown in a tubular form. The central bracket 180 is now shown having a body 170 with an upwardly extending stud 172 and a lowerly extending stud 174. Tubular end 177 of the upper rod hanger 176 forms a co-operating element of telescopic engagement with stud 172 to hold the upper hanger in place. Tubular end 179 of the lower hanger 178 forms a co-operating element of telescopic engagement with the lower extending stud 179 so as to hold the hanger 178 in place. Rods 176 and 178 are shown formed of a tubular material and the central bracket is shown having vertically extending studs 172 and 179 that may also form the co-operating elements of telescopic engagement between the central bracket and the tubes or rods 176 and 178 of the present invention.

What is shown in FIG. 19 is a cross-sectional view 19-19 through FIG. 18 of the present invention. The co-operating elements of telescopic engagement shown therein is the stud 174 engaged in the hollow portion of the tube 178. The tube shown herein are square but it is to be understood that oval sided or polygonal sided tubes may also be used for the hangers.

What is shown in FIG. 20 is a cross-sectional view through 20-20 of FIG. 18 of the present invention. In FIG. 20 is shown the lower extending hanger 178 with the central body 170 shown therein. The material 180 may be a separate piece that provides studs 172 and 174 on the bracket.

The bracket assembly described is preferably made from a metal material, preferrably from cast iron, brass, steel, aluminum, bronze, or other suitable material that gives the required strength or rigidity to hang the desired items. The shape of the rods are preferred to be rectangular when viewed in cross-section but may also be round or of an oval or polygonal nature when viewed in cross-section. The rods are preferably curved from one longitudinal end to the other.

The foregoing disclosure and description of the invention are illustrative and explanatory thereof, and various changes in the size, shape, and materials, as well as in the details of the illustrated construction may be made without departing from the scope of the claims or the spirit of the invention.

I claim:

1. A hanger for attachment to a vertical support structure, which comprises:
a central bracket having means for attachment to a vertically extending support structure and an abutment surface for contact with the vertically extending support surface,
a) a first rod hanger extending outwardly and upwardly from said bracket and having means for hanging an item thereon;
b) a second rod hanger extending outwardly and downwardly from said bracket and having means for hanging an item thereon;
c) co-operating elements of telescopic engagement means between said central bracket and said rods to hold and support said rods in place.

2. The hanger assembly according to claim 1 in which said means for attachment to the support structure comprises an adjustable belt means fastened around the perimeter of the vertically extending support structure and means on said central bracket for attachment to said adjustable belt means.

3. The hanger assembly according to claim 1 in which said central bracket further comprises an upper portion and a lower portion with vertically extending perforations formed in said upper and lower body portions for receiving and holding ends said first and second rod members.

4. The hanger assembly according to claim 1 said central bracket and said rod members are formed of the same material and which is a material selected from the group of brass, steel, bronze, copper, cast iron, aluminum, or stainless steel.

5. The hanger assembly according to claim 3 in which the rod members are rectangular when viewed in cross-sectional view.

6. The hanger assembly according to claim 3 in which the rod members are round when viewed in cross-section.

7. The hanger assembly according to claim 1 in which said cooperating elements of telescopic engagement between said rod members and said central bracket comprises an aperture formed through the body of the central bracket and the lower end of said first rod member telescopically engaged with the upper portion of said aperture and the upper end of the second rod member telescopically engaged with the lower portion of said aperture in said central bracket.

8. An hanger assembly for attachment to a vertical structure which comprises:
a) a central bracket having means for attachment to a vertical support structure and an abutment surface for contact with the vertical support structure surface;
b) a rod member extending outwardly and upwardly from said bracket and having means thereon for hanging an item.
d) cooperating elements of telescopic engagement between said rod hanger to said central bracket.

9. The hanger assembly according to claim 8 in which said means for attachment to the support structure comprises an adjustable belt means fastened around the support structure and means on said central bracket for attachment to said adjustable belt means.

10. The hanger assembly according to claim 8 in which said central bracket further comprises an upper portion and a lower portion and a perforation formed in both the upper and lower body portions of said central bracket for telescopically receiving and holding respectively said first and second rod members.

11. The hanger assembly according to claim 1 said central bracket and said rod members are formed of the same material and which is a material selected from the group of brass, steel, bronze, copper, cast iron, aluminum, or stainless steel.

12. The hanger assembly according to claim 11 in which the rod members are polygonal when viewed in cross-sectional view.

13. The hanger assembly according to claim 11 in which the rod members are round when viewed in cross-section.

14. The hanger assembly according to claim 8 in which said cooperating elements of telescopic engagement for attaching said rod members to said central bracket comprises an aperture formed through the body of the central bracket and lower end of said first rod member telescopically engaged with the upper portion of said aperture and the upper end of the second rod member telescopically engaged with the lower portion of said aperture in said central bracket.

15. A hanger assembly, which comprises:
a) a central bracket having detachable means for attachment to a vertical support structure and an abutment surface for contact with the support structure surface;
b) a first rod member extending outwardly and downwardly from said bracket and having means thereon for hanging an item.
c) co-operating elements of telescopic engagement means between said hanger and said rod to hold and support said rod in place.

16. The hanger assembly according to claim 15 in which said central bracket further comprises an upper portion and a lower portion and a hollow tubular aperture formed in both the upper and lower body portions of said central bracket for receiving and holding respectively said first and second rod members.

17. The hanger assembly according to claim 1 said central bracket and said rod members are formed of the same material and which is a material selected from the group of brass, steel, bronze, copper, cast iron, aluminum, or stainless steel.

18. The hanger assembly according to claim 16 in which the rod members are rectangular when viewed in cross-sectional view.

19. The hanger assembly according to claim 16 in which the rod members are round when viewed in cross-section.

20. The hanger assembly according to claim 16 in which said releasable means for attaching said rod members to said central bracket comprises an aperture formed through the body of the central bracket and the lower end of said first rod member telescopically engaged with the upper portion of said aperture and the upper end of the second rod member telescopically engaged with the lower portion of said aperture in said central bracket.

21. A bracket which comprises:
A body of material having
(a) means for attachment to a support structure;
(b) abutment means on said body for abutting the support structure
(c) said abutment means spaced from said attachment means along the axis of the support structure
(d) means on said body for telescopically engaging a rod element for supporting an item.

22. The bracket according to claim 20 in which said means for attachment to a support structure comprises hook means on said body.

23. The method of hanging decorative items form a support structure which comprises the steps of; forming co-operating elements of engagement between a support rod and a bracket; fastening the bracket to a vertically extending support structure; telescopically engaging a support rod with the bracket so that the rod extends outwardly from the bracket; and hanging an item on the rod member.
